(19) United States
(12) Patent Application Publication
(10) Pub. No.: US 2023/0391286 A1
(43) Pub. Date: Dec. 7, 2023

(54) AIRBAG DEPLOYMENT AROUND AN OBSTRUCTION

(71) Applicant: GM GLOBAL TECHNOLOGY OPERATIONS LLC, Detroit, MI (US)

(72) Inventors: Spencer William Chavez, Linden, MI (US); Bruce Lawrence Stone, Lake Orion, MI (US)

(21) Appl. No.: 17/829,472

(22) Filed: Jun. 1, 2022

(51) Int. Cl. B60R 21/231; B60R 21/26; B60R 21/015

(52) U.S. Cl. CPC B60R 21/231; B60R 21/26; B60R 21/01508; B60R 2021/23107; B60R 2021/26094; B60R 2021/161

(57) ABSTRACT

An airbag module having a retainer, a primary airbag cushion affixed to the retainer, a secondary airbag cushion affixed to the retainer, and an inflator, affixed to the retainer. The inflator configured to inflate the primary airbag cushion and the secondary airbag cushion. The secondary airbag cushion is configured to control a trajectory of the primary airbag cushion during deployment.

### INTRODUCTION

The disclosure relates to vehicle airbags. More specifically, the disclosure relates to an airbag system configured to deploy around an obstruction.

In general, vehicle airbags are used to protect vehicle occupants from injury in the event of a vehicle crash. Current airbag designs incorporate a variety of components that enhance the performance of the airbag. Often an airbag in a vehicle is disposed under the dashboard or trim surface of the vehicle in front of or adjacent to an occupant. In general, the airbag is located under the dashboard in a position to allow for a suitable expansion zone between the airbag and the passenger seat of the vehicle to ensure sufficient room for the deployment of the airbag. Currently, the design of the dashboard is limited, so as to not include any obstructions that interfere with the deployment of the airbag.

### SUMMARY

In one exemplary embodiment an airbag module is provided. The airbag module includes a retainer, a primary airbag cushion affixed to the retainer, a secondary airbag cushion affixed to the retainer, and an inflator, affixed to the retainer, configured to inflate the primary airbag cushion and the secondary airbag cushion. The secondary airbag cushion is configured to control a trajectory of the primary airbag cushion during deployment.

In addition to the one or more features described herein the internal pressure of the secondary airbag cushion when deployed is configured to exceed an internal pressure of the primary airbag cushion during deployment.

In addition to the one or more features described herein the primary airbag cushion includes one or more vents configured to ensure the internal pressure of the primary airbag cushion remains below a maximum pressure level.

In addition to the one or more features described herein the inflator is configured to inflate the secondary airbag cushion prior to inflating the primary airbag cushion.

In addition to the one or more features described herein the secondary airbag cushion includes a pressure relief check valve connected to the primary airbag cushion.

In addition to the one or more features described herein the pressure relief check valve is configured to ensure an internal pressure of the secondary airbag cushion remains above a minimum pressure level and below a maximum pressure level during deployment of the primary airbag cushion and the secondary airbag cushion.

In addition to the one or more features described herein the airbag module is disposed beneath a dashboard of a vehicle, wherein the secondary airbag cushion is configured to prevent interaction of the primary airbag cushion with an obstruction on the dashboard during deployment.

In another exemplary embodiment an airbag system is provided. The airbag system includes a primary airbag module having a first inflator configured to inflate a primary airbag cushion, the primary airbag module being disposed beneath a dashboard of a vehicle. The airbag system also includes a secondary airbag module having a second inflator configured to inflate a secondary airbag cushion the secondary airbag module being disposed beneath the dashboard of the vehicle. The secondary airbag cushion is configured to control a trajectory of the primary airbag cushion during deployment to prevent interaction of the primary airbag cushion with an obstruction on the dashboard during deployment.

In addition to the one or more features described herein the secondary airbag module is disposed between the primary airbag module and a passenger seat of the vehicle.

In addition to the one or more features described herein the internal pressure of the secondary airbag cushion when deployed is configured to exceed an internal pressure of the primary airbag cushion during deployment.

In addition to the one or more features described herein the primary airbag cushion includes one or more vents configured to ensure the internal pressure of the primary airbag cushion remains below a maximum pressure level.

In addition to the one or more features described herein the secondary airbag module is configured to inflate the secondary airbag cushion prior to the primary airbag module inflating the primary airbag cushion.

In addition to the one or more features described herein the secondary airbag cushion is configured to extend over the obstruction towards a passenger seat of the vehicle when deployed.

In addition to the one or more features described herein the secondary airbag cushion is configured to inflate beneath the dashboard and displace a portion of the dashboard.

In addition to the one or more features described herein the portion of the dashboard is configured to provide a reactionary surface to the primary airbag cushion during deployment to prevent the primary airbag cushion from interacting with the obstruction.

In another exemplary embodiment a vehicle having a passenger seat, a dashboard located in front of the passenger seat, the dashboard including an obstruction, and an airbag module disposed beneath the dashboard is provided. The airbag module includes a primary airbag cushion affixed to a retainer, a secondary airbag cushion affixed to the retainer, and an inflator, affixed to the retainer, configured to inflate the primary airbag cushion and the secondary airbag cushion. The secondary airbag cushion is configured to control a trajectory of the primary airbag cushion during deployment to prevent interaction of the primary airbag cushion with an obstruction on the dashboard during deployment.

In addition to the one or more features described herein the internal pressure of the secondary airbag cushion when deployed is configured to exceed an internal pressure of the primary airbag cushion during deployment.

In addition to the one or more features described herein the primary airbag cushion includes one or more vents configured to ensure the internal pressure of the primary airbag cushion remains below a maximum pressure level.

In addition to the one or more features described herein the inflator is configured to inflate the secondary airbag cushion prior to inflating the primary airbag cushion.

In addition to the one or more features described herein the secondary airbag cushion includes a pressure relief check valve connected to the primary airbag cushion, wherein the pressure relief check valve is configured to ensure an internal pressure of the secondary airbag cushion remains above a minimum pressure level and below a maximum pressure level during deployment of the primary airbag cushion and the secondary airbag cushion.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1A is a schematic diagram illustrating a portion of an interior of a vehicle having an airbag module prior to deployment of an airbag, in accordance with an exemplary embodiment;

FIG. 1B is a schematic diagram illustrating a portion of an interior of a vehicle having an airbag module after deployment of an airbag, in accordance with an exemplary embodiment;

FIG. 2 is a schematic diagram illustrating a portion of an interior of a vehicle having an airbag system with a primary airbag cushion and a secondary airbag cushion after deployment, in accordance with an exemplary embodiment;

FIG. 3 is a schematic diagram illustrating a portion of an interior of a vehicle having an airbag system with a primary airbag cushion and a secondary airbag cushion after deployment, in accordance with another exemplary embodiment;

FIG. 4 is a schematic diagram illustrating a portion of an interior of a vehicle having an airbag system with a primary airbag cushion and a secondary airbag cushion after deployment, in accordance with another exemplary embodiment; and

FIG. 5 is a disassembled view of an airbag module in accordance with an exemplary embodiment.

### DETAILED DESCRIPTION

The following description is merely exemplary in nature and is not intended to limit the present disclosure, its application or uses. Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship.

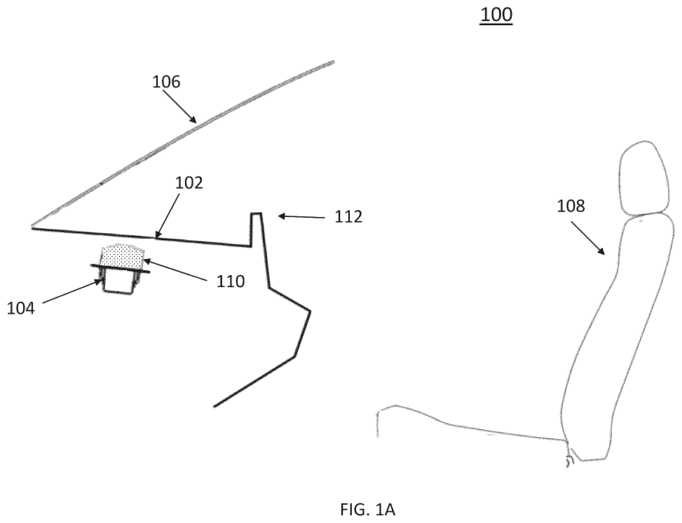

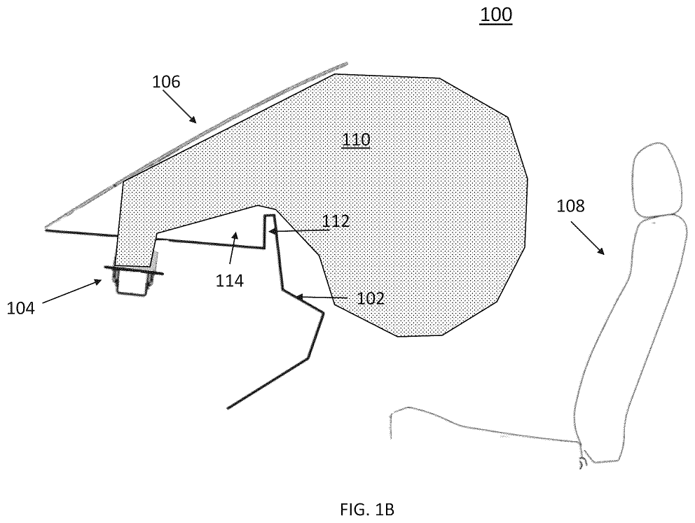

Referring now to FIGS. 1A and 1B, a portion of an interior 100 of a vehicle having an airbag module 104 are shown before and after deployment of an airbag cushion 110. FIG. 1A shows the airbag module 104 prior to deployment of the airbag cushion 110 and FIG. 1B shows the airbag module 104 after deployment of the airbag cushion 110. As illustrated, the airbag module 104 is located below a dashboard 102 and in front of a passenger seat 108. The dashboard 102 includes an obstruction 112 that may, in some cases, interfere with the deployment of the airbag cushion 110. In some cases, as best shown in FIG. 1B, as the airbag cushion 110 is deployed an air gap 114 is created between the airbag cushion and the dashboard 102 behind the obstruction 112. In other cases, especially when the obstruction 112 extends vertically up from the dashboard, the obstruction 112 may impede the deployment of the airbag cushion 110 in a direction toward the passenger seat 108. As a result, there is an increased risk of the airbag cushion 110 failing to prevent a passenger from contacting the dashboard 102 and/or the obstruction 112 during an accident.

Turning now to an overview of the aspects of the disclosure, embodiments of the disclosure include an airbag system configured to deploy around an obstruction. In exemplary embodiments, the airbag system includes a primary airbag cushion and a secondary airbag cushion, where the second airbag cushion is used to control the deployment of the primary airbag cushion. In exemplary embodiments, the secondary airbag cushion is deployed in a manner such that it ensures that the deployment of the primary airbag cushion is not affected by an obstruction in the vehicle cabin. In one embodiment, the primary airbag cushion and the secondary airbag cushion are both disposed in a single airbag module. In another embodiment, the primary airbag and the secondary airbag are disposed in separate locations in the vehicle.

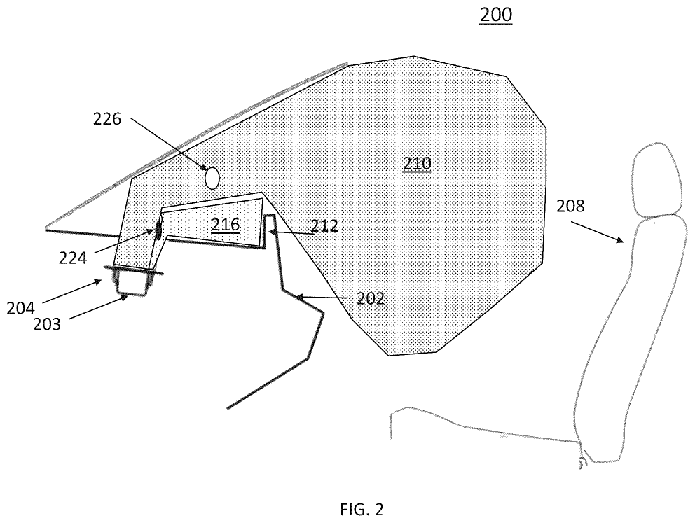

Referring now to FIG. 2 a schematic diagram illustrating a portion of an interior 200 of a vehicle having an airbag system with a primary airbag cushion 210 and a secondary airbag cushion 216 in accordance with an exemplary embodiment is shown. As illustrated, in this embodiment, both the primary airbag cushion 210 and the secondary airbag cushion 216 are affixed to a retainer 203 of an airbag module 204. Prior to deployment, both the primary airbag cushion 210 and the secondary airbag cushion 216 are disposed within the airbag module 204. In exemplary embodiments, the secondary airbag cushion 216 is configured to deploy between the primary airbag cushion 210 and the dashboard 202 to prevent interaction between the primary airbag cushion 210 and the obstruction 212 during deployment of the primary airbag cushion 210. In some embodiments, the secondary airbag cushion 216 extends over/around the obstruction 212 towards the passenger seat 208.

The secondary airbag, cushion 216 is configured to control the trajectory of the primary airbag cushion 210 during deployment. In exemplary embodiments, the secondary airbag cushion 216 is configured to provide a firm reactionary surface for the primary airbag cushion 210 to encounter during deployment. As such, an internal pressure of the secondary airbag cushion 216 when deployed is configured to exceed the pressure inside the primary airbag cushion 210 while it is being inflated. In exemplary embodiments, the primary airbag cushion 210 includes one or more vents 226 configured to ensure the internal pressure of the primary airbag cushion 210 remains below a maximum pressure level.

In exemplary embodiments, the airbag module 204 includes an inflator is configured to inflate the secondary airbag cushion 216 prior to inflating the primary airbag cushion 210. In one embodiment, the secondary airbag cushion 216 includes a pressure relief check valve 224 that fluidly connects to the primary airbag cushion 210. The pressure relief check valve 224 is configured to ensure the internal pressure of the secondary airbag cushion remains above a minimum pressure level and below a maximum pressure level during deployment of the primary airbag cushion 210 and the secondary airbag cushion 216. In one embodiment, the pressure relief check valve 224 connects the secondary airbag cushion 216 to the primary airbag cushion 210 and only allows air to travel from the secondary airbag cushion 216 into the primary airbag cushion 210 after the pressure in the secondary airbag cushion 216 exceeds a minimum pressure level. In another embodiment, the pressure relief check valve 224 connects the primary airbag cushion 210 to the secondary airbag cushion 216 and only allows air to travel from the primary airbag cushion 210 into the secondary airbag cushion 216, allowing the secondary airbag cushion to reach a maximum pressure and equilibrium prior to the check valve limiting further airflow.

In another embodiment, the airbag module 204 includes two separate inflators that are used to respectively inflate the primary airbag cushion 210 and the secondary airbag cushion 216. In one embodiment, the inflator for the primary airbag cushion 210 is configured to activate after a delay from the activation of the inflator for the secondary airbag cushion 216, thereby allowing the secondary airbag cushion 216 to inflate prior to the primary airbag cushion 210.

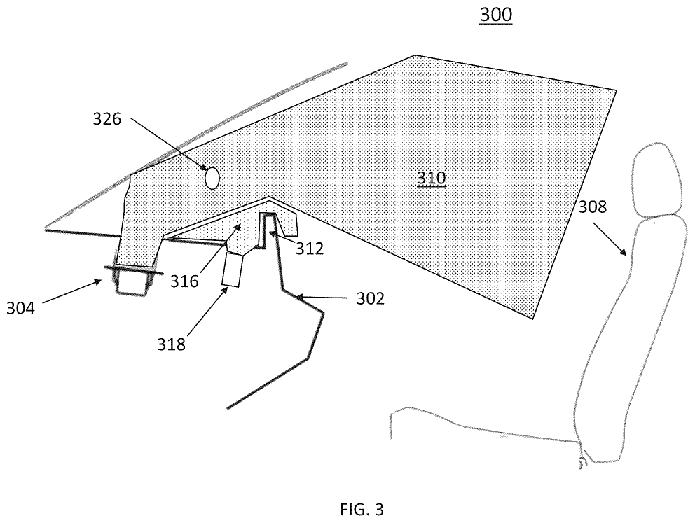

Referring now to FIG. 3 a schematic diagram illustrating a portion of an interior 300 of a vehicle having an airbag system with a primary airbag cushion 310 and a secondary airbag cushion 316 in accordance with an exemplary embodiment is shown. As illustrated, the airbag system includes a primary airbag module 304 that is located below a dashboard 302 and in front of a passenger seat 308. The airbag system also includes a secondary airbag module 318 that is located below a dashboard 302 and in front of a passenger seat 308. The secondary airbag module 318 is disposed between the primary airbag module 304 and an obstruction 312 of the dashboard 302. When deployed, the secondary airbag cushion 316 prevents the primary airbag cushion 310 from interacting with the obstruction 312. In exemplary embodiments, the secondary airbag cushion 316 is configured to extend over the obstruction 312 toward the passenger seat 308.

In exemplary embodiments, both the primary airbag module 304 and the secondary airbag module 318 include inflators that are configured to respectively inflate the primary airbag cushion 310 and the secondary airbag cushion 316. In exemplary embodiments, the secondary airbag cushion 316 is configured to provide a firm reactionary surface for the primary airbag cushion 310 to encounter during deployment. In one embodiment, an internal pressure of the secondary airbag cushion 316 when deployed is configured to exceed the pressure inside the primary airbag cushion 310 while it is being inflated. In exemplary embodiments, the primary airbag cushion 310 includes one or more vents 326 that are configured to prevent the internal pressure of the primary airbag cushion 310 from exceeding a set maximum value. In one embodiment, the secondary airbag cushion 316 does not include vents to ensure that the secondary airbag cushion 316 maintains a minimum desired pressure level. In another embodiment, the secondary airbag cushion 316 does include vents to ensure that the secondary airbag cushion 316 maintains a minimum desired pressure level.

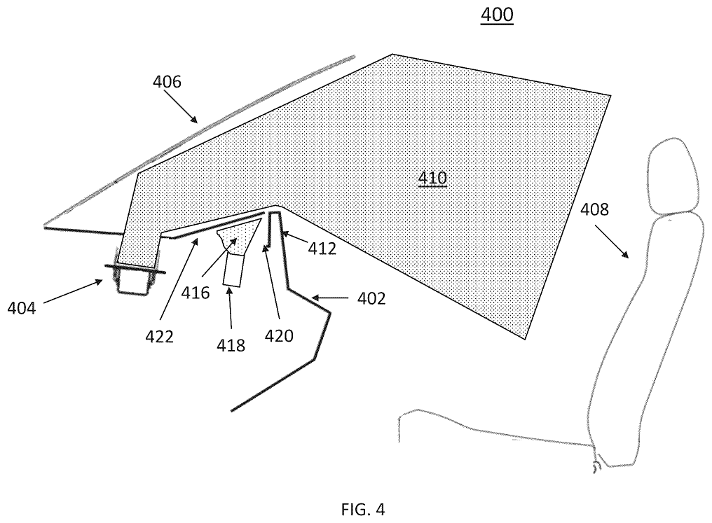

Referring now to FIG. 4 a schematic diagram illustrating a portion of an interior 400 of a vehicle having an airbag system with a primary airbag cushion 410 and a secondary airbag cushion 416 in accordance with an exemplary embodiment is shown. As illustrated, the airbag system includes a primary airbag module 404 that is located below a dashboard 402 and in front of a passenger seat 408. The airbag system also includes a secondary airbag module 418 that is located below a dashboard 402 and in front of a passenger seat 408.

In exemplary embodiments, the secondary airbag cushion 416 is configured to deploy below the surface of the dashboard 402 and to force a portion 422 of the dashboard 402 to separate, at least partially, from the remainder of the dashboard 402 at a detachment point 420. In exemplary embodiments, after deployment of the secondary airbag cushion 416, the portion 422 of the dashboard 402 is configured to provide a firm reactionary surface for the primary airbag cushion 416 to encounter during deployment. After deployment of the secondary airbag cushion 416, the portion 422 of the dashboard 402 is configured to prevent the primary airbag cushion 410 from interacting with the obstruction 412.

In exemplary embodiments, another device, such as a spring-loaded actuator or stroking piston is configured to cause the portion 422 of the dashboard 402 to separate from the dashboard 402 at the detachment point 420 and to move the portion 422 into a position to prevent the primary airbag cushion 410 from interacting with the obstruction 412.

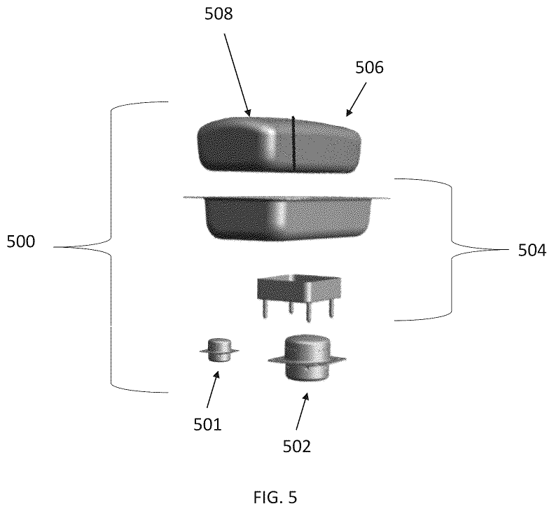

Referring now to FIG. 5, a disassembled view of an airbag module 500 in accordance with an exemplary embodiment is shown. As illustrated, the airbag module 500 includes inflators 501, 502 that are affixed to a retainer 504. In one embodiment, at least one of the inflators 501, 502 are a micro gas generator that is affixed to a retainer 504. In another embodiment, the inflator is a pyrotechnic inflator that generates gas through the combustion of the propellant. In another embodiment, the inflator is a stored gas inflator, that generates gas through the release of high pressure gases with or without combustion of a propellant. In one embodiment, the airbag module 500 includes both a primary airbag cushion 508 and a secondary airbag cushion 506. In another embodiment, the airbag module 500 includes one of a primary airbag cushion 508 and a secondary airbag cushion 506.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, (i.e., one, two, three, four, etc.). The terms “a plurality” may be understood to include any integer number greater than or equal to two, (i.e., two, three, four, five, etc.). The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An airbag module comprising:
a retainer;
a primary airbag cushion affixed to the retainer, wherein the primary airbag cushion includes one or more vents configured to ensure the internal pressure of the primary airbag cushion remains below a maximum pressure level;
a secondary airbag cushion affixed to the retainer; and
an inflator, affixed to the retainer, configured to inflate the primary airbag cushion and the secondary airbag cushion,
wherein the secondary airbag cushion is configured to control a trajectory of the primary airbag cushion during deployment,
wherein the secondary airbag cushion includes a pressure relief check valve connected to the primary airbag cushion that is configured to only allow air to travel from the primary airbag cushion into the secondary airbag cushion allowing the secondary airbag cushion to reach the maximum pressure and equilibrium with the primary airbag cushion prior to the check valve limiting further airflow from the primary airbag cushion into the secondary airbag cushion.

2. The airbag module of claim 1, wherein an internal pressure of the secondary airbag cushion when deployed is configured to exceed an internal pressure of the primary airbag cushion during deployment.

3. (canceled)

4. The airbag module of claim 1, wherein the inflator is configured to inflate the secondary airbag cushion prior to inflating the primary airbag cushion.

5. (canceled)

6. (canceled)

7. The airbag module of claim 1, wherein the airbag module is disposed beneath a dashboard of a vehicle, wherein the secondary airbag cushion is configured to prevent interaction of the primary airbag cushion with an obstruction on the dashboard during deployment.

8. An airbag, system comprising:
a primary airbag module having a first inflator configured to inflate a primary airbag cushion, the primary airbag module being disposed beneath a dashboard of a vehicle; and
a secondary airbag module having a second inflator configured to inflate a secondary airbag cushion the secondary airbag module being disposed beneath the dashboard of the vehicle;
wherein the secondary airbag cushion is configured to control a trajectory of the primary airbag cushion during deployment to prevent interaction of the primary airbag cushion with an obstruction on the dashboard during deployment.

9. The airbag system of claim 8, wherein the secondary airbag module is disposed between the primary airbag module and a passenger seat of the vehicle.

10. The airbag system of claim 8, wherein an internal pressure of the secondary airbag cushion when deployed is configured to exceed an internal pressure of the primary airbag cushion during deployment.

11. The airbag, system of claim 8, wherein the primary airbag cushion includes one or more vents configured to ensure the internal pressure of the primary airbag cushion remains below a maximum pressure level.

12. The airbag system of claim 8, wherein the secondary airbag module is configured to inflate the secondary airbag cushion prior to the primary airbag module inflating the primary airbag cushion.

13. The airbag system of claim 8, wherein the secondary airbag cushion is configured to extend over the obstruction towards a passenger seat of the vehicle when deployed.

14. The airbag system of claim 8, wherein the secondary airbag cushion is configured to inflate beneath the dashboard and displace a portion of the dashboard.

15. The airbag system of claim 14, wherein the portion of the dashboard is configured to provide a reactionary surface to the primary airbag cushion during deployment to prevent the primary airbag cushion from interacting with the obstruction.

16. A vehicle comprising:
a passenger seat,
a dashboard located in front of the passenger seat, the dashboard including an obstruction; and
an airbag module disposed beneath the dashboard, the airbag module comprising:
a primary airbag cushion affixed to a retainer, wherein the primary airbag cushion includes one or more vents configured to ensure the internal pressure of the primary airbag cushion remains below a maximum pressure level;
a secondary airbag cushion affixed to the retainer; and
an inflator, affixed to the retainer, configured to inflate the primary airbag cushion and the secondary airbag cushion,
wherein the secondary airbag cushion is configured to control a trajectory of the primary airbag cushion during deployment to prevent interaction of the primary airbag cushion with an obstruction on the dashboard during deployment,
wherein the secondary airbag cushion includes a pressure relief check valve connected to the primary airbag cushion that is configured to only allow air to travel from the primary airbag cushion into the secondary airbag cushion allowing the secondary airbag cushion to reach the maximum pressure and equilibrium with the primary airbag cushion prior to the check valve limiting further airflow from the primary airbag cushion into the secondary airbag cushion.

17. The vehicle of claim 16, wherein an internal pressure of the secondary airbag cushion when deployed is configured to exceed an internal pressure of the primary airbag cushion during deployment.

18. (canceled)

19. The vehicle of claim 16, wherein the inflator is configured to inflate the secondary airbag cushion prior to inflating the primary airbag cushion.

20. (canceled)
